(19) United States
(12) Patent Application Publication
(10) Pub. No.: US 2014/0257769 A1
(43) Pub. Date: Sep. 11, 2014

(54) PARALLEL ALGORITHM FOR MOLECULAR DYNAMICS SIMULATION

(71) Applicant: NVIDIA Corporation, Santa Clara, CA (US)

(72) Inventor: Nikolay Sakharnykh, San Jose, CA (US)

(73) Assignee: NVIDIA Corporation, Santa Clara, CA (US)

(21) Appl. No.: 13/950,848

(22) Filed: Jul. 25, 2013

Related U.S. Application Data
(60) Provisional application No. 61/773,735, filed on Mar. 6, 2013.

(51) Int. Cl. G06F 19/00

(52) U.S. Cl. CPC G06F 19/701
USPC 703/2; 703/12

(57) ABSTRACT

Systems and methods for MD simulation with significantly increased multithreaded parallelism. A substance body is divided into a plurality of cells. With respect to a current center cell, its neighbor particles can be partitioned into groups with groups processed in sequence by a dedicated CTA that comprises a plurality of warps. Within each CTA, each warp is assigned to process in parallel for a center particle in the center cell to calculate interaction forces between the center particle and the group of neighbor particles. Moreover different levels of the memory hierarchy in a system, including local memories, shared memories and global memory, are used to store intermediate and final results respectively.

### CROSSREFERENCE

The present application claims priority to U.S. Provisional Patent Application Ser. No. 61/773,735, filed Mar. 6, 2011, titled: “PARALLEL ALGORITHM FOR SHORT-RANGE INTERACTIONS,” the disclosure of which is herein incorporated by reference in its entirety.

### TECHNICAL FIELD

The present disclosure relates generally to the field of molecular dynamics simulation, and, more specifically, to the field of parallel computer controlled algorithms for molecular dynamics simulation.

### BACKGROUND

Molecular dynamics (MD) simulation has various applications in material science, biochemistry, biophysics, applied mathematics and other fields. Similar algorithms are commonly used in graphics animation and games to simulate realistic material deformation, fluid movement, etc. By MD simulation, to trace the characteristics of motion of all particles in a substance space, the overall properties of substance may be derived.

A basic idea behind molecular dynamic applications is computation of force, energy and other attributes between interacting particles. Typically, all the surrounding particles of a particular center particle are taken into account to calculate the intermolecular or interatomic forces acted on the center particle. The resultant forces acted by all surrounding particles are integrated to predicate the physical trajectory of the center particle over time. Nonetheless, the most time-consuming part of in an MD simulation is usually the force computation.

For most of the interatomic or intermolecular potential, only the short-range interactions are considered and the interaction is cut off at some distance to save on the computation cost. Due to this cut-off, only the contributions from several nearest particles are summed up in the calculation of the total force acted on a given atom. In many MD applications, it is typical to divide particles into structured grid of boxes, or cells, of sizes less than a cut-off distance and then assume interaction only between direct neighbor boxes. One example is the CoMD application that serves as a proxy software suite for many MD workloads.

The number of particles within each cell can vary for different cases and setups. There are many cases with a relatively small amount of particles per each cell. For short-range interaction simulation, there could be less than 32 or 16 particles in a cell for instance. All those particles interact only with particles in their direct neighbor cells in 3D domain, i.e. on average about a few hundred neighbor particles.

In conventional parallel MD algorithms, 1 thread is used to process for 1 particle, and accumulate forces and other data into registers. In the case of varying number of particles per cell, this leads to high execution divergence and inefficient use of high throughput hardware. Also for small grids the total number of assigned threads is not enough to provide good hardware utilization. This becomes especially important in distributed environment with multiple computational nodes and/or computationally intensive potentials where good performance on small grids is crucial. There are existing approaches using a group of threads for each box. However these approaches assume large enough number of particles in each cell to provide sufficient amount of parallelism. Therefore such algorithms are quite inefficient in the case of relatively small number of particles per box.

### SUMMARY OF THE INVENTION

It would be advantageous to provide a parallel procedure for MD simulations that can make efficient use of available hardware resources in a highly parallel architecture thereby improving the computation speed and reducing result divergence.

Accordingly, embodiments of the present disclosure provide computer process for MD simulation with significantly increased multithreaded parallelism. With the process, a substance body is divided into a plurality of cells. With respect to a current center cell, its neighbor particles can be partitioned into groups with each group processed one after another by a dedicated concurrent thread block that comprises a plurality of thread subset. Threads in a concurrent thread block are operable to synchronize with each other and share access to a fast-speed shared memory attached to the concurrent thread block. Within each concurrent thread block, each thread subset is assigned to process in parallel for a center particle in the center cell to calculate interaction forces between the center particle and the group of neighbor particles. Because the processing unit, e.g. GPU or CPU, typically allows a number of concurrent thread blocks to be simultaneously active on a single multiprocessor, this process advantageously provides sufficient parallelism to populate the multiprocessors and allow multithreading to keep the processing cores productive. Moreover, the process uses hierarchy local memory, shared memory and global memory to store intermediate and final results respectively, which advantageously optimizes memory accesses and further reduces computation speeds.

In one embodiment of present disclosure, a computer implemented method of simulating molecular dynamics of particles in a substance space comprises: (1) dividing the substance space into a plurality of cells, a respective cell comprising a first number of center particles and surrounded by a second number of neighbor particles; (2) dividing the second number of neighbor particles into groups; (3) assigning a respective thread block for computing interactions between the first number of center particles and the second number of neighbor particles, processing the respective groups of neighbors one by one sequentially accumulating the results, wherein execution threads in the respective thread block are operable to synchronize with each other and share access to a respective on-chip shared memory; (4) assigning a respective thread subset for computing interactions between one or more of the first number of center particles and the respective group and (5) processing in parallel execution threads in the respective thread subset to compute interactions between each of the one or more center particles and the respective group to produce local results. The method may further comprises: (1) storing local results to local storage devices, wherein each of the local storage devices is associated with a respective execution thread of the respective thread subset, each of the local results representing a computed interaction between a respective of the one or more center particles and one or more of neighbor particle; (2) storing accumulated results to the respective on-chip shared memory, wherein each of the accumulated results is derived from local results and represents an accumulative interaction between the respective of the one or more center particle and the corresponding group of neighbor particles; and (3) storing global results to a global memory to which the plurality of thread blocks share access, wherein each of the plurality of global results is derived from accumulated results and represent an accumulative interaction between each of the first number of center particles and the second number of neighbor particles. The local storage devices operate faster than the respective on-chip shared memory. The respective on-chip shared memory operates faster than the global memory.

In another embodiment of present disclosure, a system for molecular dynamics simulation comprises: a plurality of processors; and a memory hierarchy coupled with the plurality of processors. The memory hierarchy comprises: a global memory accessible to a plurality of thread blocks; a plurality of shared memories, each accessible to a respective thread block; and a plurality of registers, each accessible to a respective execution thread of a respective thread block. The system further comprises a non-transient computer-readable recording medium storing a molecular dynamics (MD) simulation program that causes the plurality of processors to perform: (1) dividing the substance space into a plurality of cells, each cell comprising a first number of center particles and surrounded by a second number of neighbor particles; (2) dividing the second number of neighbor particles into groups of neighbor particles; (3) storing local results to the plurality of registers respectively, wherein each of the local results (4) represents a respective computed interaction between a respective center particle and one or more neighbor particle of a respective group of neighbor particle; (5) storing accumulated results to the plurality of shared memories, wherein each of the accumulated results is derived from local results related to a respective center particle and represents an accumulative interaction between a respective center particle and a respective group of neighbor particles; and (6) storing global results to the global memory, wherein each of the global results is derived from accumulated results relating to a respective center particle, where further each of the global results representing an accumulative interaction between the respective center particle and the groups of neighbor particles. The MD simulation program may further comprise instructions that cause the plurality of processors to perform: (1) assigning a respective thread block for computing interactions between a respective center particles and a respective group of neighbor particles, wherein execution threads in the respective thread block are operable to synchronize with each other; and (2) assigning a respective thread subset of a respective thread block for computing interactions between one or more of the first number of center particles and a respective group of neighbor particles; and (3) processing in parallel execution threads in the respective thread subset to compute interactions between each of the one or more of the first number of center particles and the respective group of neighbor particles to produce local results.

In another embodiment of present disclosure, a system for molecular dynamics simulation comprises: (1) a global memory accessible to a plurality of cooperative thread arrays (CTA); (2) graphic processing unit (GPU) comprising: a plurality of multiprocessors; a plurality of shared memories, each accessible to a respective CTA; a plurality of registers, each accessible to a respective execution thread; and (3) a non-transient computer-readable recording medium storing a molecular dynamics (MD) simulation program causing the GPU to perform: (a) dividing the substance space into a plurality of cells, each cell comprising a first number of center particles and surrounded by a second number of neighbor particles; (b) dividing the second number of neighbor particles into groups of neighbor particles; (c) computing interactions between the first number of center particles and all groups of neighbor particles by a first CTA; processing one group after another; and (d) computing interactions between a first center particle and the first group of neighbor particles by a first subset of the first CTA, wherein execution threads of the first thread subset are configured to process in parallel for computing interactions between the first center particle and the first group of neighbor particles.

This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 illustrates the parallel granularity levels and the memory hierarchy in an exemplary GPU computing model that can be employed for MD simulation in accordance with an embodiment of the present disclosure.

FIG. 2 is a diagram illustrates an exemplary assignment of a thread block and thread subsets in computing forces acted on particles of a particular center cell by their neighbor particles using a parallel algorithm of MD simulation in accordance with an embodiment of the present disclosure.

FIG. 3A illustrates exemplary partitioning of the neighbor particle groups in accordance with an embodiment of the present disclosure.

FIG. 3B illustrates exemplary mapping of thread subsets to the center particles in accordance with an embodiment of the present disclosure.

FIG. 4 is a flow chart illustrating an exemplary computer implemented method of computing interaction forces acted on each particle in a substance body by virtue of MD simulation in accordance with an embodiment of the present disclosure.

FIG. 5 is a flow chart illustrating an exemplary computer implemented method of computing interactive forces acted on particles in a current center cell by virtue of MD simulation in accordance with an embodiment of the present disclosure.

FIG. 6 is a flow chart illustrating an exemplary computer implemented method of computing interaction forces acted on each center particle by a respective group of neighbor particles through an assigned thread block by virtue of MD simulation in accordance with an embodiment of the present disclosure.

FIG. 7 is a flow chart illustrating an exemplary computer implemented method of computing interaction forces acted on a center particle through individual threads in the assigned warp by virtue of MD simulation in accordance with an embodiment of the present disclosure.

FIG. 8 illustrates an exemplary configuration of a computing system comprising a multiprocessor system operable to process an MD simulation based on a parallel algorithm in accordance with an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature:

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

### Parallel Algorithm for Molecular Dynamics Simulation

The modern GPU has evolved from a fixed function graphics pipeline to a programmable parallel processor with computing power that exceeds that of multicore central processing unit. Although the parallel process in accordance with the present disclosure can be executed in graphic processing units (GPU) as well central processing units (CPU), a GPU may offer a preferred platform due to its lightweight thread creation overhead and capability of running thousands of threads at full efficiency.

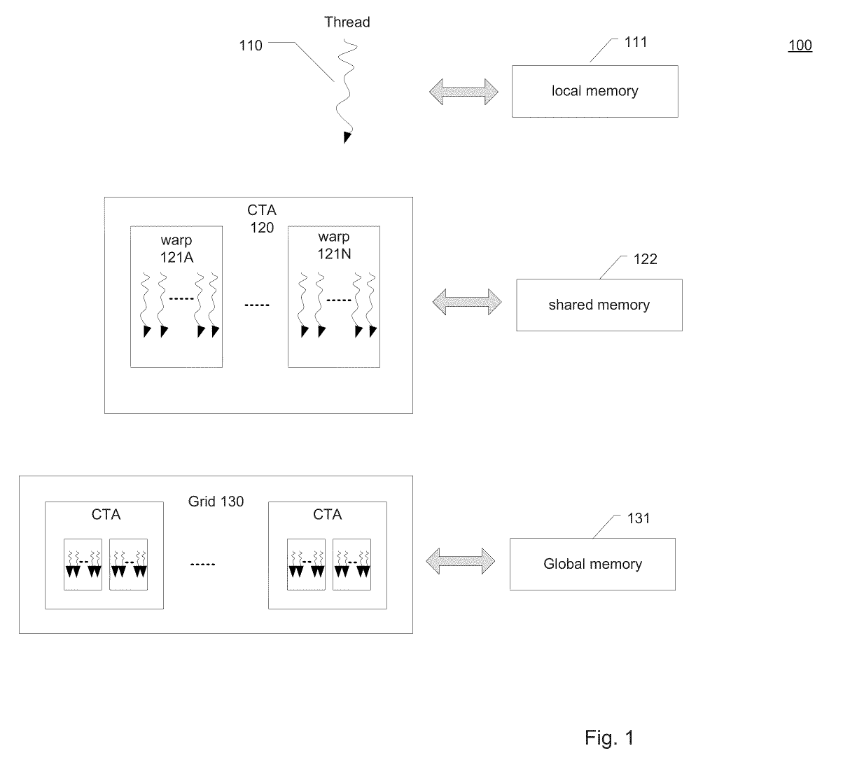

FIG. 1 illustrates the parallel granularity levels and corresponding memory hierarchy in an exemplary GPU computing model 100 that can be employed for MD simulation in accordance with an embodiment of the present disclosure. The fundamental granularity level comprises individual execution threads 110, each operable to execute a sequence of programmed instructions managed by an operating system scheduler. Each thread may be associated with a private local memory, such as registers, for data spill, stack frame, and addressable temporary variables.

A higher level of the computing model 100 is composed of thread blocks 120, each of which has a configurable number of concurrent threads, e.g. from 2 to 512, and is associated with a shared memory accessible to the concurrent threads. For example, the illustrated model may be the CUDA™ computing platform in a NVIDIA™ GPU, in one instance, and so the thread blocks correspond to cooperative thread arrays 120 (CTAs). Threads in a CTA can execute the same application program, synchronize, communicate, share data, and cooperate to compute a result. Each CTA is associated with an on-chip shared memory 122 accessible all constituent threads in the CTA and yet inaccessible to other CTAs. A shared memory 122 usually operates in fast speeds comparable to register speeds, low-latency, and high-bandwidth, in contrast to an off-chip global memory. A shared memory typically has limited capacity, e.g. 16 KB or 48 KB depending on the architecture.

In the illustrated model 100, each thread block 120 is divided into a number of thread subsets, which may be the smallest units to process data in a single instruction multiple data fashion (SIMD). Thread subsets may correspond to warps in a CTA block and each has hardware-fixed 32 threads of the same type, e.g. vertex, geometry, pixel, or compute work distribution.

A further higher level of the illustrated computing model 100 includes sequential grids 130, each having a plurality of thread blocks. CTAs in the same grid execute independently of each other and can share data through the off-chip global memory 131.

Provided a computing model similar to FIG. 1, an MD simulation program in accordance with the present disclosure decomposes a simulation problem into sections that can be computed independently in parallel by a plurality of thread blocks. The program further decomposes each section of problem into elements that can be processed by individual threads cooperatively in parallel, advantageously populating the multiprocessors and allowing multithreading to keep the processors productive. In this manner, the program can make thousands of threads run concurrently. Moreover, the simulation program utilizes hierarchy of local memory, shared memory and global memory to store intermediate and final results respectively, which reduces inter-level data change and thereby further improving computation efficiency. In addition, the problem decomposition and utilization of memory hierarchy allows a user to relate and segregate the computation results efficiently.

With respect to a specific simulation problem, assuming the substance space is divided into a plurality of two dimensional or three dimensional cells, e.g. M×M×M, in the space coordinate system. In accordance with the present disclosure, neighbor particles of a particular cell (the center cell) are divided into groups. A thread block is assigned to process the computation for interactions between all the groups and all the particles in the center cell. A particular group of neighbors is processed in parallel by the assigned thread block. Neighbors are divided into groups because of limitations on the shared memory capacity in the current hardware. Thus, for a particular center cell, a single thread block processes neighbors groups one after another to accumulate results from all neighbors of the center cell. In some embodiments, the number of threads allocated in a thread block is equal to the number of neighbor particles in the neighbors group. Further, each subset in a thread block is assigned to one center particle in the center cell. Threads in a subset process in parallel the computation for interactions between the group of neighbors and a respective center particle.

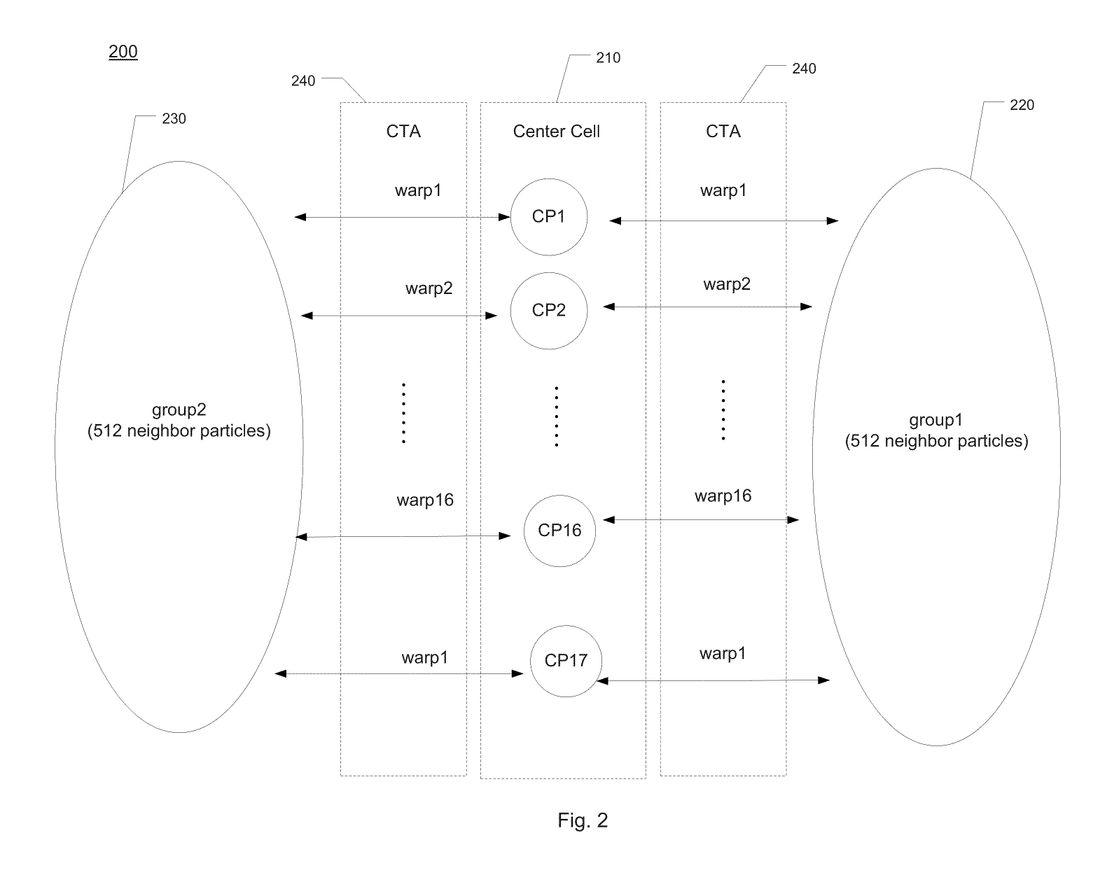

FIG. 2 illustrates an exemplary assignment of a thread block and thread subsets in computing forces acted on particles of a particular center cell 210 by their neighbor particles using a parallel algorithm of MD simulation in accordance with an embodiment of the present disclosure. In this example, the center cell 210 contains 17 center particles for instance and is surrounded by 1024 neighbor particles. Assuming the CTA is allocated with 512 threads, the 1024 neighbor particles are accordingly divided into 2 groups evenly, namely group1 220 and group2 230.

Specifically, the thread block CTA 240 is first assigned for computing interaction forces between each of the 17 center particles and the neighbor particles in group1 220. The resultant forces are stored in the shared memory associated with CTA. Thereafter, CTA is assigned for computing interaction forces between each of the 17 center particles and the neighbor particles in group2 230. The resultant forces are also stored in the shared memory. The number of neighbor particles allocated for a group may be limited by the shared memory capacity. In some other embodiments, instead of utilizing a CTA to process for all groups of neighbor particles in sequence, a plurality of CTAs can be assigned to process for the plurality of group in parallel, e.g., with each CTA processes for a respective group.

In this exemplary instance, the assigned CTA 240 comprises 16 warps, where a respective warp is responsible for one or more corresponding center particles. More explicitly, warps 1˜16 are respectively assigned for computing forces acted on center particles CP1˜16 by group1 neighbor particles. For example, the 32 threads in warp1 process in parallel for computing and accumulating the forces acted on CP1 by the neighbor particles in group1 220.

Thus, each thread in a particular warp is assigned for computing forces acted on a corresponding center particle by a few neighbor particles in the corresponding group. In average, the number of neighbor particles that each thread processes is equal to the group size divided by the warp size. The local result from this thread is stored in its local memory, e.g. a register. For example, a particular execution thread in warp1 processes program instructions for computing the accumulative force acted on center particle CP1 by

$$16 ( = \frac{512}{32} )$$

neighbor particles in group1 220. Each time a local result is generated by a respective execution thread, e.g. the interaction force between CP1 and one of the 16 neighbor particles, it is added to the private local memory dedicated to the particular thread. Thus, when one thread of warp1 finishes a process for CP1, the particular private local memory stores a single value representing the accumulative force acted on CP1 by 16 particles. The registers in a warp may only be accessible within the warp.

After a warp finishes processing with respect to one center particle, the 32 local results stored in the registers are typically reduced to a single value representing an accumulation of the local results and to be saved to the shared memory. Thus, the accumulated result represents the accumulative force acted on CP1 by all particles in group 1.

In the illustrated example, because the number of particles in the center cell is greater than the number of warps in the CTA 240, warp 1 is also assigned for CP 17. In some embodiments, different warps in the CTA may perform the assigned computation sequentially due to limited capacity of the shared memory associated with the CTA.

After the CTA finished processing with respect to a particular center particle, the corresponding accumulated results may be summed up to derive a global result to be saved to the global memory. Thus, each global representing accumulative force acted on a respective center particle by all the neighbor particles.

Besides interaction forces, the parallel process in accordance with the present disclosure can be equally effective in computing energy, potential, or alike between particles. Based on the calculated interactions, properties that describe the current state of a particle, such as acceleration, velocity, position, etc., can be derived.

Particles referred to herein can be anything that can be simulated, e.g., atoms, molecules, ions, sub-atomic particles, clusters, or combinations thereof. It will be appreciated that the parallel process for MD simulation is not limited to any particular method of dividing the substance space, the numbers of particles included in each cell, or specific potential models used for computation. For example, in the case that the neighbor particles are located from a center particle in widely different scales, different potential models may be used for different neighbor particles.

In some embodiment, the length of each edge of each cell is equal to or greater than a predetermined cut-off radius. In this case, the neighbor particles are located only in the immediately adjacent cells. If the distance of two particles is greater than the cut-off distance, the interactions between the two particles will be ignored by the simulation process.

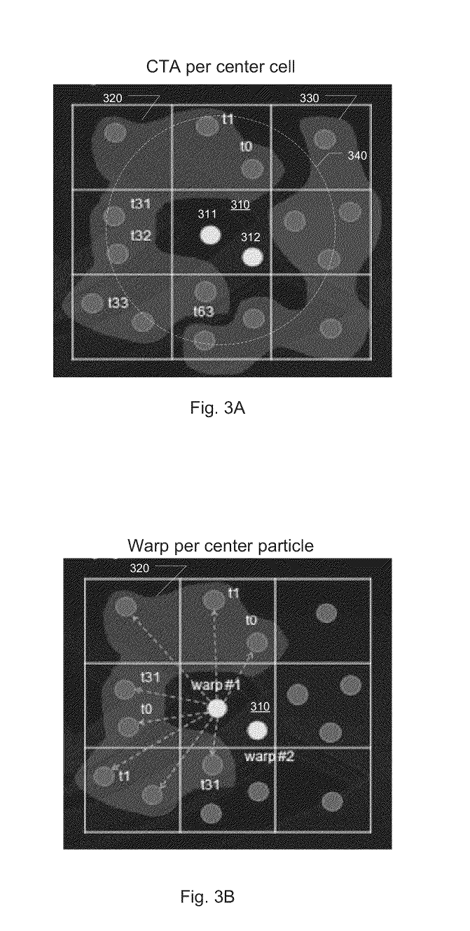

FIG. 3A illustrates exemplary partitioning of the neighbor particle groups in accordance with an embodiment of the present disclosure. The current center cell 310 contains two center particles 311 and 312 that are surrounded by 27 immediately adjacent cells in three dimensions which encompasses 128 neighbor particles (partially shown). The 128 neighbor particles are divided into two groups 320 and 330, each group is processed by the assigned CTA. The CTA has 128 execution threads with each thread dedicated to a particular neighbor particle. The circle 340 marks the cut-off distance with respect to interactions. In some embodiments, neighbor particles located out of the cut-off range can be removed from the force calculation.

FIG. 3B illustrates exemplary mapping of thread subsets to the center particles in accordance with an embodiment of the present disclosure. Warp1 (dashed lines) of the CTA is dedicated to the center particle 311. Warp2 of the CTA is dedicated to the other center particle 312.

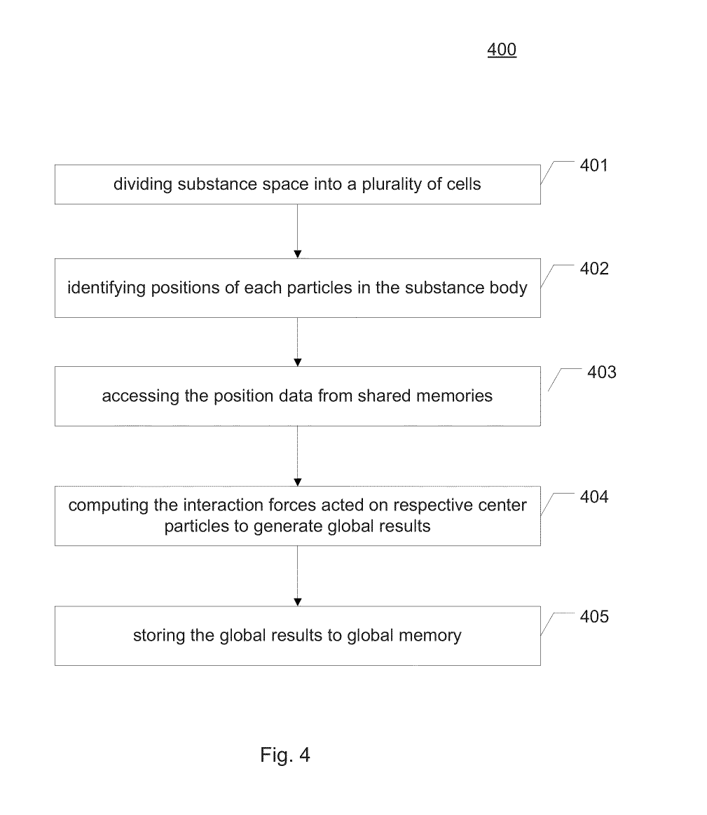

FIG. 4 is a flow chart illustrating an exemplary computer implemented method 400 of computing interaction forces acted on each particle in a substance body by virtue of MD simulation in accordance with an embodiment of the present disclosure. Process 400 may be software executed on a computer system comprising a graphics processor. At 401, a substance space of a certain state is divided into a plurality of cells, each cell containing a plurality of particles. Positions of all particles with respect to a coordinate system defined for the substance body are identified at 402. The position data are accessed at 403. All the positions may be stored in a global memory of the GPU initially. The positions of a group of neighbor particles may be loaded to a shared memory for faster access during computation. In some embodiments, especially for short range interaction simulations, the cell sizes are defined to be equal to or greater than the cutoff distance, and only particles in the 27 most adjacent cells, including the other particles in the center cell, surrounding a center particle are considered as neighbor particles for force computation.

At 404, pairwise interaction force between each center particle and each of its neighbor particles is calculated based on the distance thereof. Interaction forces acted on each center particle by all neighbor particles are accumulated to generate the global results which are stored to the global memory at 405. In some embodiments, if it is determined that a distance between a neighbor particle and the center particle is greater than a cut-off distance, the neighbor particle can be removed from computation for forces acted on the center particle. Thus, each global result represents the accumulative force acted on a particular particle in the substance body and can be used to predict the motion, or location of the particular particle. In some embodiments, double computation of the interaction force between each pair of particles can be avoided.

The present disclosure is not limited by the potential or field force models used for MD simulation. The interaction force computation can be based on any type of potential models, such as pair potentials, many-body potentials, empirical forces, embedded data model (EDM) forces, Lennard-Jones potentials, Tersoff potentials, Tight-Binding Second Moment Approximation (TBSMA) potentials, etc.

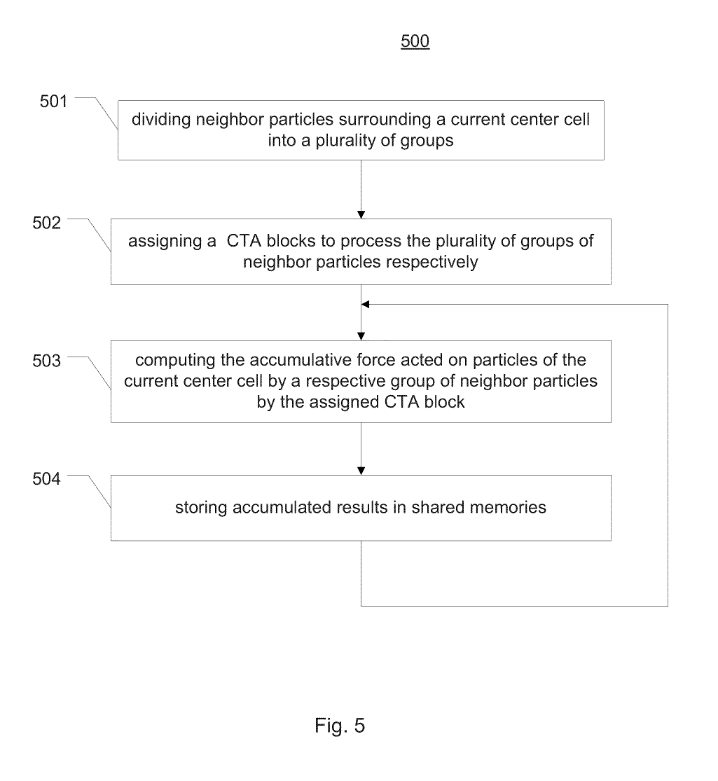

FIG. 5 is a flow chart illustrating an exemplary computer implemented method 500 of computing interactive forces acted on particles in a current center cell by virtue of MD simulation in accordance with an embodiment of the present disclosure. Process 500 may be software executed on a computer system comprising a graphics processor. The method 500 is similar to block 404 in FIG. 4. At 501, the neighbor particles surrounding a center cell are divided into a plurality of groups. At 502, a thread block, e.g. a CTA block, is assigned to process the plurality of groups, the thread block processes groups in sequence accumulating the results from each group. At 503, interaction forces acted on particles of the center cell by its neighbor particles in a respective group are computed by an assigned CTA and accumulated to generate the respective accumulated result. At 504, the respective accumulated result is stored in the shared memory associated with the assigned CTA. The foregoing 503 and 504 are repeated for each group of neighbor particles with respect to the each particle in the center cell.

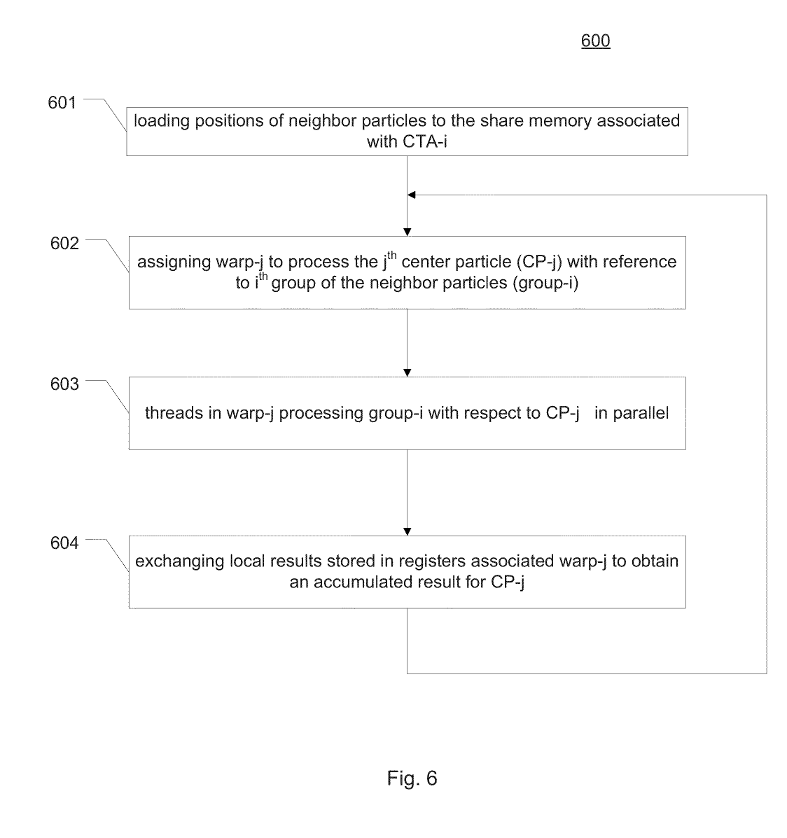

FIG. 6 is a flow chart illustrating an exemplary computer implemented method 600 of computing interaction forces acted on each center particle by a respective group of neighbor particles through an assigned thread block by virtue of MD simulation in accordance with an embodiment of the present disclosure. Process 600 may be software executed on a computer system comprising a graphics processor. The method 600 is similar to block 503 in FIG. 5. At 601, the threads in the assigned CTA (CTA-i) cooperate to load positions of neighbor particles of the respective group (group-i) positions into the shared memory associated with the assigned CTA (CTA-i). In some embodiments, one thread load exactly one neighbor particle positions. The threads synchronize to ensure all data is loaded.

At 602, a respective thread subset, e.g. a warp (warp-j), of the thread block (CTA-i) is assigned to process the center particle (CP-j) with respect to the group-i neighbor particles. As described in details with reference to FIG. 2, a respective thread subset may process for more than one center particle depending on the number of warps in the assigned CTA (CTA-i) and the number of center particles in the current center cell.

At 603, the threads in the warp-j compute forces acted on the corresponding center particle (CP-j) by the respective group of neighbor particles (group-i) in parallel. Each thread in warp-j processes an average of (group size/warp size) number of neighbor particles and generates a local result to be updated to a respective local memory associated with the thread. A local memory may store an accumulation of local results from an individual thread, thus the accumulation representing interaction forces acted on the CP-j by a number of neighbor particles.

At 604, the local results generated from all threads of warp-j are exchanged to obtain a single value accumulated result representing accumulative interaction force acted on CP-j by group-i. The threads of warp-j may exchange data with each other directly without going through shared or global memory. In some embodiments, the threads can do warp-level reduction exchanging forces within warp-j using available shuffle operations without consuming shared memory space.

The accumulated result is added to the corresponding shared memory location for CP-j. The foregoing 602-604 are repeated for each incremented j, i.e. for each center particle. As described in details with reference to FIG. 2, a warp may be responsible to more than one center particle.

In some embodiments, a thread subset processes for computing forces on all neighbor particles in a particular group, including the neighbor particles out of the cut-off distance. In some other embodiments, the particles beyond the cut-off range can be removed from the force computation to further improve the efficiency and reduce diversion of a thread subset. For example, a warp may first compute the distances between the corresponding center particle and each neighbor particle in the corresponding group. Accordingly, a binary mask comprising indexes “1”s and “0”s can be created to identify the neighbor particles in and out of the cut-off distance respectively. Then a compaction operation is performed on the mask to select the particles within the cut-off distance. Thus, the threads in the warp are assigned to process force computation only on these selected particles, resulting in less particles for computation and storing and thereby additionally improving execution speed. In some embodiments, the binary mask can be saved in the shared memory.

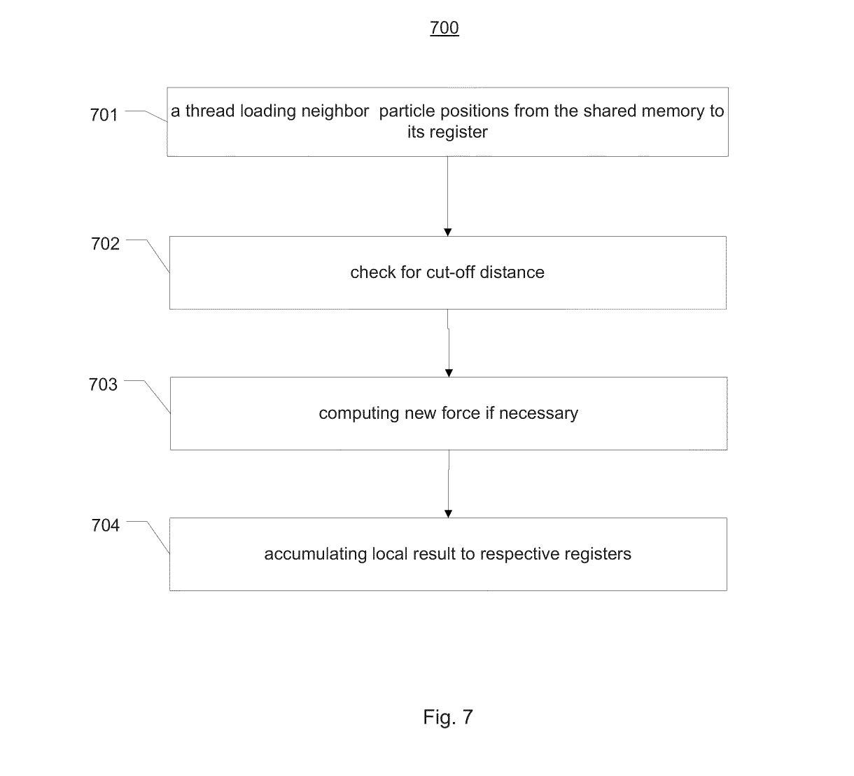

FIG. 7 is a flow chart illustrating an exemplary computer implemented method 700 of computing interaction forces acted on a center particle through individual threads in the assigned warp by virtue of MD simulation in accordance with an embodiment of the present disclosure. Method 700 is similar to 603 in FIG. 6. At 701, a respective thread of the assigned warp loads a respective neighbor position from shared memory to a corresponding register. At 702, the respective thread compares the loaded position with the cut-off distance. At 703, the respective thread computes new forces if needed. At 704, the respective thread accumulates the local result to its local memory. The foregoing 701-704 are repeated as each thread may averagely process (group size/warp size) number of neighbor particles.

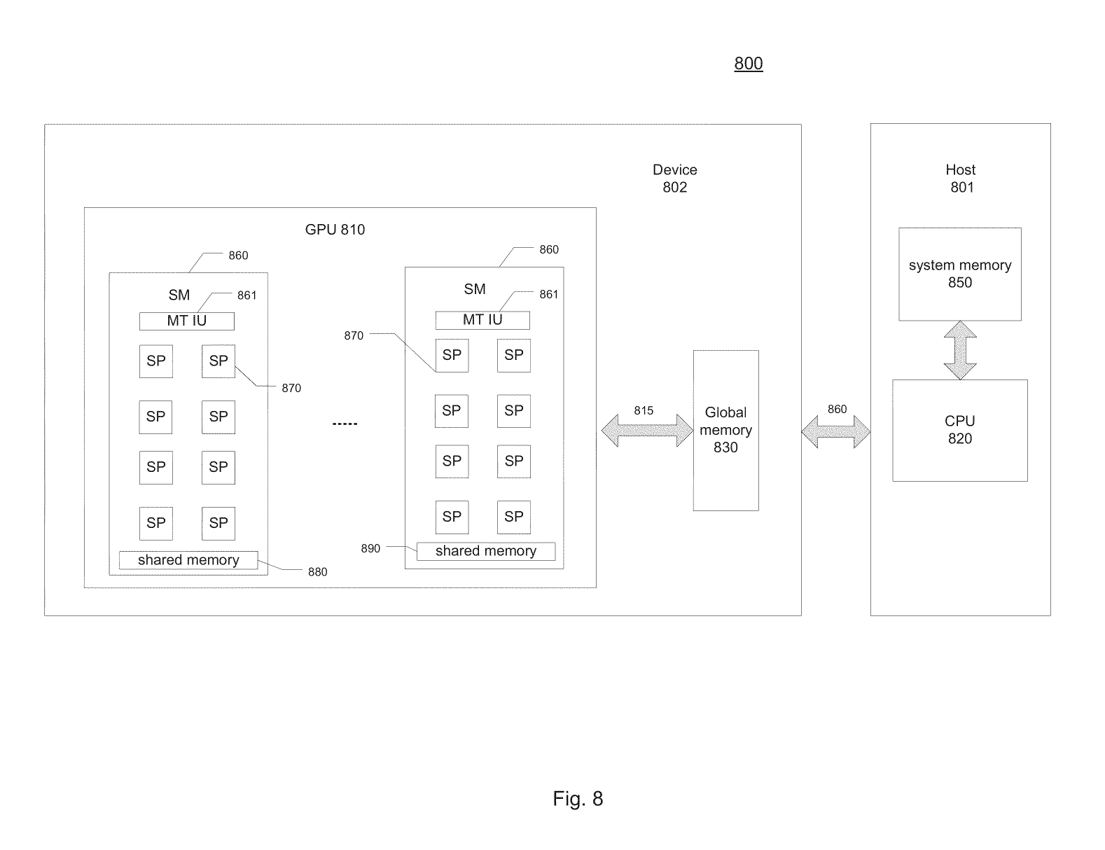

FIG. 8 illustrates an exemplary configuration of a computing system 800 comprising a multiprocessor system operable to process an MD simulation based on a parallel algorithm in accordance with an embodiment of the present disclosure. The computing system 800 comprises a host 801 and a GPU device 802. The host 801 comprises CPU 820 and system memory 850. The device 802 comprises a programmable GPU 810 with a multiprocessor architecture global memory 830. The GPU 810 comprises a host interface unit (not shown) operable to communicate with the host CPU 820, respond to commands from the CPU 820, fetches data from system memory 850, check command consistency, and performs context switching. The host 801 is coupled to the device 802 through a bus 860, such as a Peripheral Component Interconnect Express (PCI-e) bus, a motherboard-level interconnect, point-to point serial link bus, or a shared parallel bus. The system memory 850 may store instructions for a MD simulation program that comprises instructions for mapping the computing problem to the processing architecture, e.g. the GPU 810.

The GPU 810 may comprise a plurality of streaming-processor (SP) cores 870 organized as an array of streaming multiprocessors (SM) 860. In this example, each SM comprises multiple SPs 870, a multithreaded instruction issue unit MT IU 861 and a shared memory 880. For example, the shared memory may have a capacity of 16 Kb or 48 Kb depending on the processor architecture. The array of SMs 870 may be capable of executing vertex, geometry, and pixel-fragment shader programs and parallel computing programs, such as the MD simulation program in accordance with an embodiment of the present disclosure. Each SM may further comprise special function units, instruction cache, and other functional units.

A share memory 880 within each SM 860 may hold graphic input buffers or shared data for parallel computing as described above. A low-latency interconnect network between the SPs 870 and the shared memory 880 banks provides shared memory access. Threads on one SM may not have accessible to a shared memory located in another SM.

Each SM can execute in parallel with the others. A SM is hardware multithreaded and capable of efficiently executing hundreds of threads in parallel, e.g. with zero scheduling overhead. Concurrent threads of computing programs can synchronize at a barrier with a single SM instruction. For example, each SM may execute up to eight CTAs concurrently, depending on CTA resource demands. Threads in different CTAs can be assigned to different multiprocessors concurrently, to the same multiprocessor, concurrently, or may be assigned to the same or different multiprocessor at different times, depending on how the threads are scheduled dynamically.

For example, in a single-instruction multiple-thread (SIMT) architecture, a MT IU 861 can creates, manages, schedules, and executes threads in a subset of 32 parallel threads, e.g. in a warp. For example, a SM may manage a pool of 64 warps, with a total of 2048 threads. Individual threads composing a SIMT warp are of the same type and start together at the same program, but they are otherwise free to branch and execute independently. At each SIMT multithreaded instruction issue time, a SIMT MT IU 861 selects a warp that is ready to execute and issues the next instruction to that warp's active thread. A SIMT instruction can be broadcast synchronously to a wrap's active parallel threads; individual threads can be inactive due to independent branching or prediction.

A SM 860 maps the warp threads to the SPs 870, and each thread executes independently with its own instruction address and register state.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A computer implemented method of simulating particle dynamics in a substance space, said computer implemented method comprising:
dividing said substance space into a plurality of cells, a respective cell comprising a first number of center particles and surrounded by a second number of neighbor particles;
dividing said second number of neighbor particles into groups of neighbor particles;
assigning a thread block for computing interactions between said first number of center particles and a respective group of said groups of neighbor particles, wherein execution threads in said thread block are operable to synchronize with each other and share access to a respective on-chip shared memory;
assigning a respective thread subset of said thread block for computing interactions between one or more of said first number of center particles and said respective group of neighbor particles; and
processing in parallel execution threads in said respective thread subset to compute interactions between each of said one or more center particles and said respective group of neighbor particles to produce local results.

2. The computer implemented method of claim 1 further comprising:
storing local results to local storage devices, wherein each of said local storage devices is associated with a respective execution thread of said respective thread subset, each of said local results representing a computed interaction between a respective of said one or more center particles and one or more of neighbor particle of said respective group of neighbor particles;
storing accumulated results to said respective on-chip shared memory, wherein each of said accumulated results is derived from local results and represents an accumulative interaction between said respective of said one or more center particle and said corresponding group of neighbor particles; and
storing global results to a global memory to which a plurality of thread blocks share access, wherein each of said plurality of global results is derived from accumulated results and represent an accumulative interaction between each of said first number of center particles and said second number of neighbor particles, wherein said local storage devices operate faster than said respective on-chip shared memory, and wherein further said respective on-chip shared memory operates faster than said global memory.

3. The computer implemented method of claim 2, wherein said respective on-chip shared memory is inaccessible to execution threads excluded from said respective thread block.

4. The computer implemented method of claim 2 further comprising exchanging local results stored in local storage devices associated with said respective thread subset to generate a respective accumulated result.

5. The computer implemented method of claim 1 further comprising:
assigning a respective execution thread of said thread block for loading a position of a respective neighbor particle of said respective group to said respective on-chip shared memory, wherein execution threads in said thread block are configured to synchronize to ensure completion of said loading; and
assigning a respective execution thread of said respective thread subset for loading a position of a respective neighbor particle of said respective group from said on-chip shared memory to a local storage device associated with said respective execution thread of said respective thread subset.

6. The computer implemented method of claim 1, said second number of neighbor particles are located in cells immediately adjacent to said respective cell.

7. The computer implemented method of claim 2, wherein said local results comprise interaction forces between corresponding center particles and corresponding neighbor particles computed in accordance with an embedded atom model (EAM) and based on relative positions thereof.

8. The computer implemented method of claim 1 further comprising: assigning said thread block for computing another group of neighbor particles subsequent to computing said respective group of particles, wherein further said respective thread subset comprises a predetermined number of execution threads, said predetermined number is unconfigurable to users.

9. The computer implemented method of claim 1, wherein said respective thread subset is assigned for computing interactions related to said one or more of said center particles one center particle after another.

10. The computer implemented method of claim 1 further comprising:
assigning a thread subset for computing distances between a corresponding center particle and corresponding neighbor particles;
creating a binary mask mapping neighbor particles with respect to a cut-off distance; and
performing compaction on said binary mask to remove neighbor particles located beyond said cut-off distance from computing interactions related to said corresponding center particle.

11. A system for molecular dynamics simulation, said system comprising
a plurality of processors;
a memory hierarchy coupled with said plurality of processors, said memory hierarchy comprising: a global memory accessible to a plurality of thread blocks; a plurality of shared memories, each accessible to a respective thread block; a plurality of registers, each accessible to a respective execution thread of a respective thread block; and
a non-transient computer-readable recording medium storing a molecular dynamics (MD) simulation program, said MD simulation program comprising instructions that cause said plurality of processors to perform:
dividing said substance space into a plurality of cells, each cell comprising a first number of center particles and surrounded by a second number of neighbor particles;
dividing said second number of neighbor particles into groups of neighbor particles;
storing local results to said plurality of registers respectively, wherein each of said local results represents a respective computed interaction between a respective center particle and one or more neighbor particle of a respective group of neighbor particle;
storing accumulated results to said plurality of shared memories, wherein each of said accumulated results is derived from local results related to a respective center particle and represents an accumulative interaction between a respective center particle and a respective group of neighbor particles; and
storing global results to said global memory, wherein each of said global results is derived from accumulated results relating to a respective center particle, where further each of said global results representing an accumulative interaction between said respective center particle and said groups of neighbor particles.

12. The system of claim 11, wherein said MD simulation program further comprises instructions that cause said plurality of processors to perform:
assigning a respective thread block for computing interactions between a respective center particles and a respective group of neighbor particles, wherein execution threads in said respective thread block are operable to synchronize with each other; and
assigning a respective thread subset of a respective thread block for computing interactions between one or more of said first number of center particles and a respective group of neighbor particles; and
processing in parallel execution threads in said respective thread subset to compute interactions between each of said one or more of said first number of center particles and said respective group of neighbor particles to produce local results.

13. The system of claim 11, wherein said MD simulation program further comprises instructions that cause said processors to perform:
assigning a respective execution thread of a respective thread block for loading a position of a respective neighbor particle of a corresponding group to a corresponding shared memory, wherein execution threads in said respective thread block are configured to synchronize to ensure completion of said loading; and
assigning a respective execution thread of a respective thread subset for loading a position of a respective neighbor particle of said corresponding group from said corresponding shared memory to a corresponding register.

14. The system of claim 12, wherein each of said local results represents a computed potential energies between said respective center particle and said corresponding neighbor particle of said corresponding group based on a distance thereof.

15. The system of claim 12, wherein said MD simulation program further comprises instructions that cause said processors to perform assigning said respective thread subset for computing interactions relating to a first center particle subsequent to computing interactions relating to a second center particle.

16. The system of claim 12, wherein said MD simulation program further comprises:
assigning a respective thread subset for computing distances between a respective center particle and a corresponding group of neighbor particles;
creating a binary mask mapping said corresponding group of neighbor particles with reference to a cut-off distance; and
performing compaction on said binary mask to remove neighbor particles located beyond said cut-off distance from computing interactions with reference to said respective center particle.

17. A system for molecular dynamics simulation, said system comprising
a global memory accessible to a plurality of cooperative thread arrays (CTA);
a graphic processing unit (GPU) comprising:
a plurality of multiprocessors;
a plurality of shared memories, each accessible to a respective CTA;
a plurality of registers, each accessible to a respective execution thread;
a non-transient computer-readable recording medium storing a molecular dynamics (MD) simulation program, said MD simulation program comprising instructions that cause said GPU to perform:
dividing said substance space into a plurality of cells, each cell comprising a first number of center particles and surrounded by a second number of neighbor particles;
dividing said second number of neighbor particles into groups of neighbor particles;
computing interactions between said first number of center particles and groups of neighbor particles by a first CTA; and
computing interactions between a first center particle and said first group of neighbor particles by a first subset of said first CTA, wherein execution threads of said first thread subset are configured to process in parallel for computing interactions between said first center particle and said first group of neighbor particles.

18. The system of claim 17, wherein said MD simulation program further comprises instructions that cause said GPU to perform:
computing interactions between a second center particle and said first group of neighbor particles by said first thread subset of said first CTA subsequent to computing interactions between said first center particle and said first group of neighbor particles;
storing local results to a first plurality of registers, wherein each of said first plurality of registers is associated with a respective execution thread of said first thread subset, wherein each of said local results represents a computed interaction between said first center particle and one or more of neighbor particle of said first group of neighbor particles;
storing accumulated results to a first shared memory associated with said first CTA, each of said accumulated results representing an accumulative interaction between said first or said second center particle and said first group of neighbor particles;
computing interactions between said first number of center particles and a second group of neighbor particles by said first CTA; and
storing global results to said global memory, wherein each of said global results represent an accumulative interaction between said first or said second center particles and said groups of neighbor particles,
wherein said first plurality of registers operate faster than said first shared memory which operates faster than said global memory.

19. The system of claim 17, wherein said MD simulation program further comprises instructions that cause said GPU to perform:
computing distances between said first center particle and said first group of neighbor particles by said first thread subset;
creating a binary mask mapping said corresponding group of neighbor particles with reference to a cut-off distance; and
performing compaction on said binary mask to remove neighbor particles located beyond said cut-off distance from computing interactions with reference to said first center particle.

20. The system of claim 17, wherein said MD simulation program further comprises instructions that cause said GPU to perform:
loading a position of a respective neighbor particle of said first group to said first shared memory by said first CTA, wherein execution threads in said respective thread block are configured to synchronize to ensure completion of said loading; and
loading a position of a first neighbor particle of said first group from said first shared memory to a corresponding register by said first thread subset.
